(19) United States
(12) Patent Application Publication
(10) Pub. No.: US 2005/0190155 A1
(43) Pub. Date: Sep. 1, 2005

(54) Computer mouse carried on the palm of the hand

(76) Inventor: Adam S. Pollenz, Solvang, CA (US)

Correspondence Address: THE INVENTORS NETWORK, INC., 332 ACADEMY STREET, CARNEGIE, PA, 15106, US

(21) Appl. No.: 10/788,394

(22) Filed: Mar. 1, 2004

(51) Int. Cl. G09G 5/00

(52) U.S. Cl. 345/163

(57) ABSTRACT

A computer mouse is attachable to the hand of the computer operator so that the computer mouse can be carried and cradled within the palm of the computer operator's hand includes a housing having a curvilinear upper surface for conforming to the operator's palm and a strap that extends over the back of the operator's hand for securement at the front of the computer mouse thereby attaching the mouse to the operator's hand. A mouse ball or sensor at the front of the mouse is thus controlled by the operator's thumb while the operator's index finger controls the left click button and the operator's middle finger controls the right click button.

### FIELD OF THE INVENTION

The present invention pertains to an ergonomically designed computer mouse, and, more particularly, pertains to a computer mouse that attaches to the user's hand for controlling cursor movement on a CRT screen.

### BACKGROUND OF THE INVENTION

A computer mouse is a user interface device that allows the computer operator or user to move a cursor about the two-dimensional plane of the computer-generated video display screen so that any number of control functions can be initiated at any point on the video display screen. Among the most common control functions supported by various operating systems and software systems are the “select” function and the “drag” function. The computer mouse can be connected by a cable to the operating system—or the mouse can be wireless—and the mouse is moved by the operator on a flat surface whereby the motion is translated to the x-y plane of the video display screen for moving the cursor arrow. The mouse further includes several click buttons for further controlling and manipulating various computer system functions.

Several problems arise with the use of the conventional computer mouse. One obvious problem is that in order to move the cursor, the user must take one hand off the keyboard to manipulate the mouse. Productivity over time can be greatly diminished from this activity of continuously moving one hand back and forth between the keyboard and the mouse. In addition, repetitive stress injuries to the fingers, wrist and forearm are quite common, and are generally believed to result from the continuous stroking of the click buttons of the mouse by the operator's index finger. The painful and enervating condition known as carpal tunnel syndrome is believed to arise from such repetitive action.

In order to reduce and alleviate the above problems, the prior art discloses a number of computer mouse designs that enhance the flexibility and ergonomics of the computer mouse.

For example, the Maynard Jr. patent (U.S. Pat. No. 5,260,696) discloses a computer mouse that utilizes multiplane facets on its underside so that the whole mouse movement may provide additional signaling dependent on which facets of the mouse housing is brought into contact against the operating desk surface.

The Kaneko et al. patent (U.S. Pat. No. 5,414,445) discloses a pointing device having such ergonomic features as a relatively low back height, a minimal slope from the back to the high point, a narrow width at the front of the device, location of the rotatable ball adjacent the grip axis for enhancing the feel of control and responsibility, and rounded edges for further comfort.

The Wambach patents (U.S. Pat. Nos. 5,444,462 and 6,097,369) disclose embodiments for a glove worn on the computer operator's hand that include motion sensors for detecting lateral wrist motion, click buttons on the various fingers of the glove for controlling mouse click functions so that all mouse functions are supported on one hand of the computer operator.

The Benja-Athon patent (U.S. Pat. No. 6,266,047 B1) discloses an ergonomically designed mouse having a 30-degree incline relative to a horizontal surface and left and right click buttons that utilize only the thumb and fifth digit for manipulating the mouse.

### SUMMARY OF THE INVENTION

The present invention comprehends an ergonomically designed computer mouse that is attachable to the computer operator's hand, and is carried within the operator's palm, so that the computer mouse moves with the natural movements of the operator's wrist, hand, and arm thereby alleviating and eliminating the physical discomfort and injury that occurs as a result of the repetitive stress from using a conventional computer mouse that must maintain contact with the desk or work surface.

The computer mouse of the present invention includes an elongated, curvilinear body that tapers to a rear portion for receiving the cable connection. The upper surface of the mouse has a curvature for comfortably conforming to the palm of the operator's hand, lo and a flexible strap extends from the rear portion to the front portion of the mouse, and-is attachable at the front portion of the mouse. The operator slips his or her hand through the strap so that the strap extends over the back of the hand and the mouse is cradled within the user's palm. The operator's thumb can thus control the mouse ball or sensor at the front of the mouse, the operator's index finger can control the left click button, and the operator's middle finger can control the right click button.

It is an objective of the present invention to provide a computer mouse attachable to the palm of the user's hand so that the arm, elbow and wrist do not have to be extended thereby alleviating the repetitive stress syndrome on the hand, wrist, arm and shoulder.

It is yet another objective of the present invention to provide a computer mouse attachable to the palm of the user's hand that reduces and alleviates the conditions leading to carpal tunnel syndrome thereby increasing worker productivity.

It is still yet another objective of the present invention to provide a computer mouse attachable to the palm of the user's hand that allows the individual to use the computer mouse without lifting the fingers from the keyboard.

Still yet another objective of the present invention is to provide a computer mouse attachable to the palm of the user's hand that allows for a more relaxed and comfortable posture while seated at the computer workstation.

A still further objective of the present invention is to provide a computer mouse attachable to the palm of the user's hand that obviates the need for a mouse pad and provides the user with a less cluttered workspace.

A still yet further objective of the present invention is to provide a computer mouse that is carried within the user's palm and eliminates the need to constantly pick up the mouse to reposition the cursor arrow on the CRT screen.

These and other objects, features, and advantages will become to one skilled in the art upon a perusal of the following detailed description read in conjunction with the accompanying drawing figures.

### BRIEF DESCRIPTION OF THE DRAWINGS

FIG. 1 is a perspective view of the computer mouse of the present invention illustrating the sensor ball, the left and right click buttons, and the pliable strap for attaching the mouse to the user's hand and under the palm;

FIG. 2 is a top plane view of the computer mouse of the present invention illustrating the disposition of the computer mouse beneath the user's palm and transverse thereto;

FIG. 3 is a side elevational view of the computer mouse of the present invention illustrating the manipulation of the left and right click buttons by the user's index finger and middle finger;

FIG. 4 is a perspective view of the computer mouse of the present invention illustrating the use of an adapter so that a conventional mouse and the computer mouse of the present invention can both communicate with the computer through the same port; and

FIG. 5 is a perspective view of the computer mouse of the present invention illustrating the cordless embodiment for the computer mouse.

### DETAILED DESCRIPTION OF THE PREFERRED EMBODIMENT

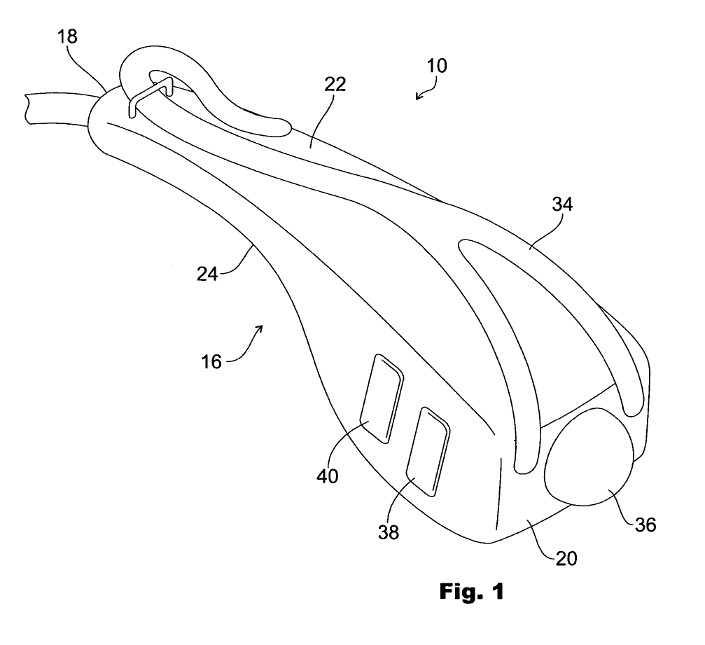

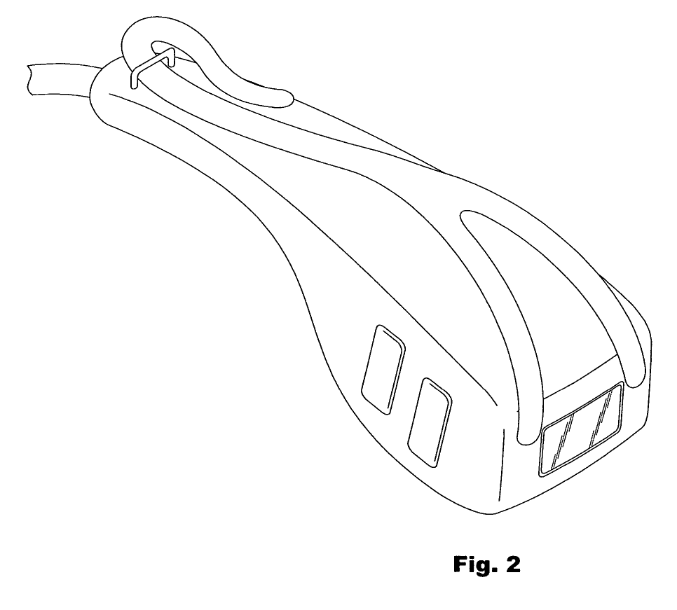

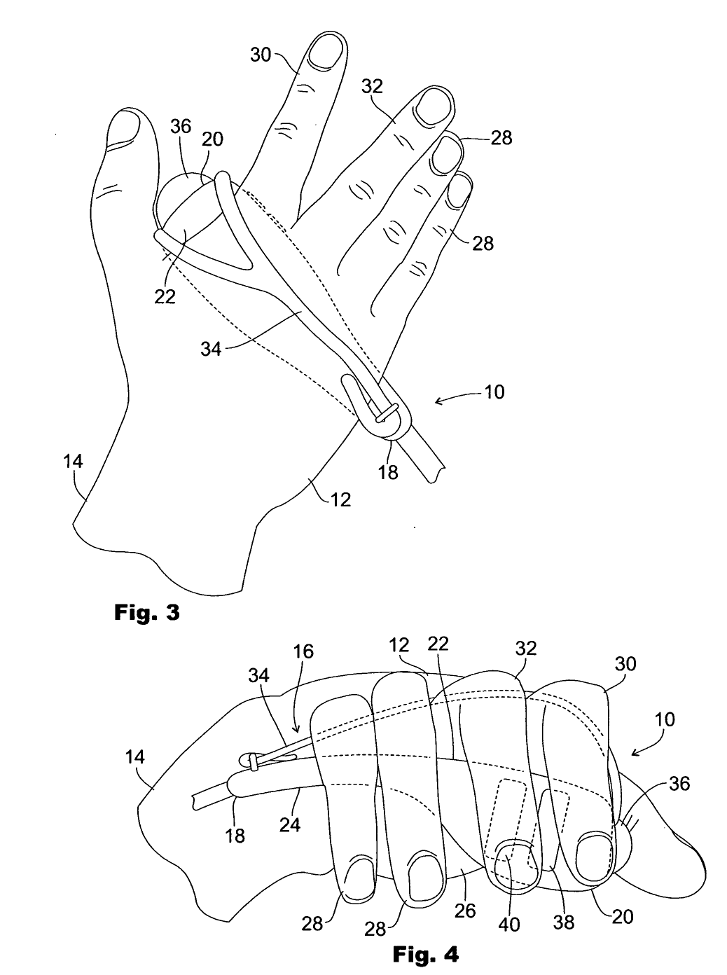

Illustrated in FIGS. 1-5 is a computer mouse 10 that fits and is attachable to the hand 12 of the computer operator or user and moves with the natural motion or movements of the hand 12, wrist 14 and arm of the operator or user for controlling and moving the cursor arrow about the two-dimensional plane surface of the video display screen. By attaching the computer mouse 10 to the hand 12 of the operator, the physical awkwardness and strain resulting from continuously reaching for, manipulating and moving a desktop positioned computer mouse is avoided. Thus, the various types of repetitive stress injuries, such as carpal tunnel syndrome, are alleviated or completely eliminated, the need for a mouse pad is also eliminated, and the workspace is freed up for other purposes.

As shown in FIGS. 1-5, the computer mouse 10 of the present invention fits and is fastened to the operator's hand 12 includes an elongated housing 16 having a rear portion 18 and an opposite front portion 20. The housing 16 tapers toward the rear portion 18, and the housing 16 further includes an upper surface 22 and an opposite lower surface 24. The upper surface 22 has a curvature or a curvilinear contour in order to accommodate and comfortably receive the palm 26 of the operator's hand 12. The curvature of the upper surface 22 of the housing 16 facilitates the fit and cradling of the mouse 10 within the palm 26 of the operator's hand 12. In addition, the lower surface 24 of the housing 16 also includes a sloping or curvilinear contour to accommodate the gripping and clasping of the lower surface 24 of the housing 16 by the remaining fingers 28 of the operator's hand 12. Thus, the housing 16 is ergonomically designed to comfortably fit within the palm 26 of the operator's hand 12, and to accommodate the movements of the operator's fingers 28—including the index finger 30 and the middle finger 32—as he or she manipulates the various mouse 10 controls.

As shown in FIGS. 1-3, in order to attach the computer mouse 10 to the hand 12 of the operator, a flexible strap 34 is provided that extends from the rear portion 18 to the front portion 20 of the housing 16. The strap 34 is a padded Velcro r strap through which the operator's hand 12 can be slipped for fastening the mouse 10 to the hand 12 of the operator. The computer mouse 10 of the present invention can be configured to support various types of controls and buttons. As shown in FIGS. 1-3, the computer mouse 10 includes a thumb-controlled mouse ball 36—or a thumb controlled sensor—adjacent the front portion 20 of the housing 16 for controlling such computer functions as the click and drag functions. Adjacent one side of the housing 16—the right side as the mouse 10 would normally be cradled within the palm 26 of the right hand 12—are two buttons. More specifically, the mouse 10 includes a left click button 38 that is controlled by the index finger 30 and a right click button 40 that is controlled by the middle finger 32.

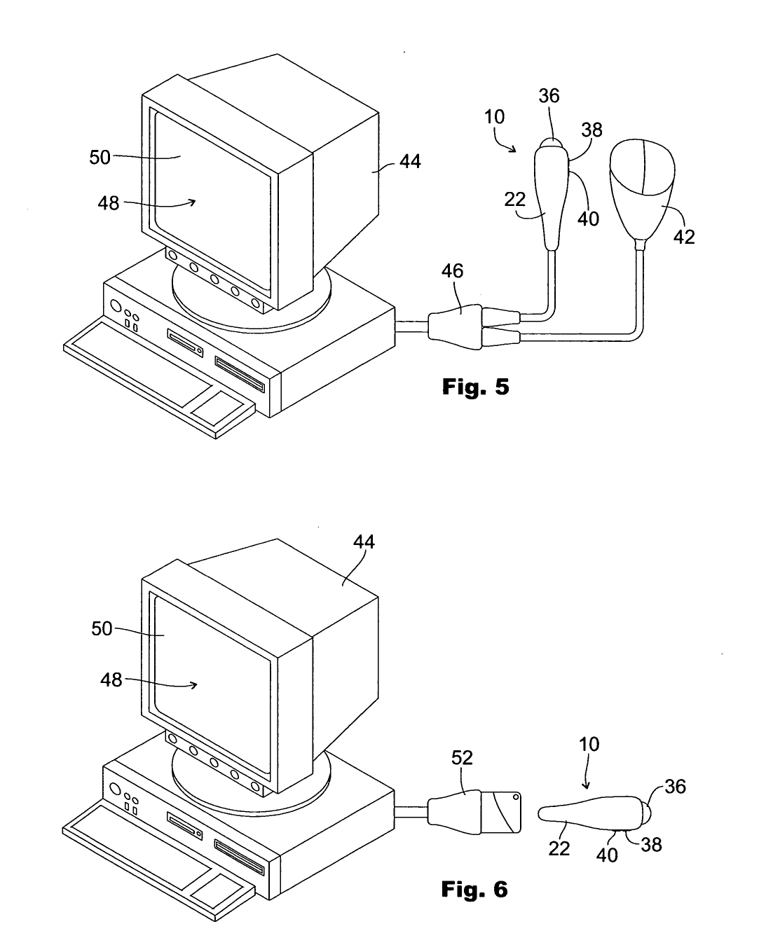

As shown in FIG. 4 and 5, the computer mouse 10 can come in both a cordless and a corded embodiment for providing maximum flexibility in use. Thus, in FIG. 4 both the computer mouse 10 of the present invention, and a conventional mouse 42, are interconnected to and interfaced with the requisite computer port of the computer 44 through an adapter 46 for controlling the movements of the cursor 48 about the two-dimensional plane surface of the video display screen 50. This allows the operator to choose which mouse 10 or 42 he or she wants to use for a given computer task. FIG. 5 illustrates the cordless embodiment for the mouse 10 and the wireless receiver 52 that is interfaced with a predetermined computer port or slot thereby allowing the operator or user to perform other tasks, such as giving speeches or presentations, without being tethered and confined to the computer 44.

While the invention has been described in specific detail, numerous modifications, alterations, or variations may occur to those skilled in the art, and may be made without departing from the spirit and scope of the invention disclosed herein or the appended claims.

1. A computer mouse that is attachable to the hand of the computer operator and cradled within the palm of the operator's hand for controlling the movement of the cursor on the video display screen of the computer, comprising:
a housing having a front portion, an opposite rear portion, an upper surface and an opposite lower surface;
the upper surface having a curvilinear contour for accommodating the palm of the operator's hand;
the lower surface having a sloping contour for facilitating the gripping of the housing by the operator's fingers;
a computer mouse ball located at the front portion of the housing and manually controlled by the thumb of the operator;
a left click button mounted adjacent to the front portion and manipulated by the index finger of the operator for controlling certain computer functions in conjunction with the positioning of the cursor on the screen;
a right click button mounted adjacent the left click button and manipulated by the middle finger of the operator for controlling certain computer functions conjunction with the positioning of the cursor on the screen; and
means to removably fasten the computer mouse to the hand of the operator and within the palm of the operator's hand.

2. The computer mouse of claim 1 wherein the means for fastening the mouse to the operator's hand includes a flexible strap that extends from the front portion to the rear portion of the housing and through which the operator's hand is passed so that the operator can grip the computer mouse in the palm of his hand.

3. The computer mouse of claim 2 further comprising an adapter for interconnecting both the computer mouse and a conventional computer mouse to the computer.

4. The computer mouse of claim 3 wherein the mouse is able to make a wireless interconnection to the computer for controlling cursor movement by communication with a wireless receiver.

5. A computer mouse that is attachable to the hand of a computer user and cradled within the palm of the user for controlling the movements of the cursor on the video display screen of the computer and other computer functions, comprising:
a housing having a front portion, an opposite rear portion, an upper surface and an opposite lower surface;
the upper surface having a sloping contour for accommodating the palm of the user's hand;
the lower surface having a sloping contour for facilitating the comfortable gripping of the housing by the user's fingers;
a computer mouse ball located adjacent the front portion of the housing and manipulated by the user's thumb with the mouse ball initiating certain computer functions such as the click and drag functions;
a left click button mounted on the housing adjacent the front portion and manipulated by the user's index finger for controlling computer functions coincident with the movement and positioning of the cursor on the screen;
a right click button mounted on the housing adjacent the left click button and manipulated by the user's middle finger for controlling computer functions coincident with the movement and positioning of the cursor on the computer screen; and
means to fasten the computer mouse to the user's hand and within the palm of the user so that the computer mouse moves with the natural movements of the user's hand for moving and controlling the positioning of the cursor on the video display screen and is not in contact with the work surface.

6. The computer mouse of claim 5 wherein the means to fasten the mouse to the hand of the user includes a flexible strap that extends from the front portion to the rear portion of the housing and through which the user's hand is slipped for gripping and cradling the mouse within the user's palm.

7. The computer mouse of claim 6 further comprising an adapter for interconnecting both the computer mouse and a conventional mouse to the computer so that the user can select which mouse to use for a given computer function.

8. The computer mouse of claim 7 further comprising a wireless configuration whereby the computer mouse interfaces with the computer through a wireless receiver for controlling the movement and positioning of the cursor and other computer functions through manipulation of the mouse ball and the left and right click buttons.
